(19) United States
(12) Patent Application Publication
(10) Pub. No.: US 2025/0240718 A1
(43) Pub. Date: Jul. 24, 2025

(54) DYNAMIC RESOURCE CANCELLATION FOR DEVICE-TO-DEVICE DATA COMMUNICATION

(71) Applicant: Samsung Electronics Co., Ltd., Suwon-si (KR)

(72) Inventors: Bilal Sadiq, Plano, TX (US); Vishnu Vardhan Ratnam, Plano, TX (US); Boon Loong Ng, Plano, TX (US); Abhishek Sehgal, Plano, TX (US)

(21) Appl. No.: 19/026,105

(22) Filed: Jan. 16, 2025

Related U.S. Application Data
(60) Provisional application No. 63/624,250, filed on Jan. 23, 2024.
(60) Provisional application No. 63/723,889, filed on Nov. 22, 2024.

(51) Int. Cl. H04W 52/02; H04W 76/28

(52) U.S. Cl. CPC H04W 52/0229; H04W 76/28

(57) ABSTRACT

The first device establishes a data path with the second device, agrees on a set of resource blocks with the second device for communication on the data path. The first device transmits, to the second device, a message indicating when the first device cancels a portion of the set of resource blocks so that the second device is refrained from transmitting data to the first device during canceled portion of the set of resource blocks on the data path. The first device cancels the portion of the set of resource blocks for receiving data on the data path. The first device is allowed not to listen on the data path during the cancelled portion of the set of resource blocks.

### CROSS-REFERENCE TO RELATED APPLICATIONS

This application claims the benefit of priority from U.S. Provisional Application No. 63/624,250 entitled “DYNAMIC RESOURCE CANCELLATION FOR DEVICE-TO-DEVICE DATA COMMUNICATION,” filed Jan. 23, 2024, and U.S. Provisional Application No. 63/723,889 entitled “DYNAMIC RESOURCE CANCELLATION FOR DEVICE-TO-DEVICE DATA COMMUNICATION,” filed Nov. 22, 2024, which is incorporated herein by reference in its entirety.

### TECHNICAL FIELD

This disclosure relates generally to a wireless communication system, and more particularly to, for example, but not limited to, dynamic resource cancellation for device-to-device data communication in a wireless communication system.

### BACKGROUND

Many device-to-device discovery technologies or many communication technologies require the two or more devices to agree on a set of time and frequency (channel) resources where the devices may communicate. These agreed upon resources are often referred to as a schedule or common resource blocks (CRBs) such as in Neighborhood Aware Networking (NAN). On the CRBs, even when the devices are not transmitting or receiving, they nevertheless remain in a listen state so that they can receive a transmission from a peer device if the peer device were to transmit on the CRBs. However, outside of CRBs, on resources where a device has no other wireless communication operation, the device may enter a lower power state such as a doze or sleep state.

It may be desirable to allow a device to dynamically cancel some CRBs if the link between devices has been inactive for a certain duration. This may prove particularly useful for so-called bursty traffic. For example, in long term evolution (LTE) and new radio (NR) specify discontinuous reception (DRX) procedure. In the DRX procedure, while the base station (BS) is expected to remain awake, the BS operating as a master device can configure the user equipment (UE) operating as a follower device to dynamically abandon the listen state if the link between the BS and the UE has been inactive for certain duration. Similarly, in the infrastructure wireless local area network (WLAN) operation, an access point (AP) station (STA) can indicate an early termination of a service period to a non-AP station based on a link inactivity or a duration of an empty medium access control (MAC) buffer, which allows the non-AP STA to abandon a listen state on the remain duration of the on-going service period.

### SUMMARY

The present disclosure is directed to improvements in wireless communication. In particular, the present disclosure is directed to reduction of power consumption in the wireless communication.

In this disclosure, an inactivity-based power-save (PS) operation for data communication between devices in a device-to-device network or mesh network, such as NAN Data Path (NDP) connection between devices in a NAN cluster are disclosed. In some aspects, the operation of devices will be described using as an example an NDP between devices that are part of a NAN cluster. In some embodiments, each device on an NDP may be able to determine its own PS or DRX configuration and may cancel some CRBs independently from the other device's PS or DRX configuration. This may be particularly useful in a mesh network where devices may have NDP established with multiple peers and there may not be a central or master entity coordinating a harmonious PS or DRX configuration among devices.

In some embodiments, an electronic apparatus for facilitating communication in a wireless network comprises a memory; and a processor operably coupled to the memory. The processor is configured to cause: establishing a data path with a wireless communication device; agreeing on a set of resource blocks with the wireless communication device for communication on the data path; transmitting, to the wireless communication device, a message indicating when the electronic apparatus cancels a portion of the set of resource blocks so that the wireless communication device is refrained from transmitting data to the electronic apparatus during canceled portion of the set of resource blocks on the data path; and cancelling the portion of the set of resource blocks for receiving data on the data path, wherein the electronic apparatus is allowed not to listen on the data path during the cancelled portion of the set of resource blocks.

In some embodiments, the message indicates that the electronic apparatus cancels the portion of the set of resource blocks when a response to the message is received, and cancelling the portion of the set of resource blocks comprises: cancelling the portion of the set of resource blocks when the response to the message is received.

In some embodiments, wherein the processor is further configured to cause: restoring the cancelled portion of the set of resource blocks when successful data transmission or reception associated with the data path is made.

In some embodiments, the message indicates that the electronic apparatus cancels the portion of the set of resource blocks when the data path is inactive in the electronic apparatus for a duration,

wherein cancelling the portion of the set of resource blocks comprises: determining whether the data path is inactive in the electronic apparatus for the duration, and cancelling the portion of the set of resource blocks based on a determination that the data path is inactive in the electronic apparatus for the duration.

In some embodiments, determining whether the data path is inactive in the electronic apparatus for the duration comprises: determining that the data path is inactive in the electronic apparatus for the duration when no successful data transmission or reception associated with the data path is made for the duration.

In some embodiments, the message includes a parameter indicating the duration.

In some embodiments, determining whether the data path is inactive in the electronic apparatus for the duration comprises: determining that the data path is inactive in the electronic apparatus for the duration if the duration ends at a time belonging to an active resource block excluding an observation window located at the beginning of the active resource block.

In some embodiments, determining whether the data path is inactive in the electronic apparatus for the duration comprises: determining that the data path is inactive in the electronic apparatus for the duration if the duration ends at a time not belonging to any active resource blocks and if the data path remains inactive during a predetermined time in one or more active resource blocks.

In some embodiments, determining whether the data path is inactive in the electronic apparatus for the duration comprises: determining that the data path is inactive in the electronic apparatus for the duration if the duration ends at a time belonging to an observation window located at the beginning of an active resource block and if the data path remains inactive during a predetermined time in one or more active resource blocks.

In some embodiments, the message includes information indicating which portion of the set of resource blocks is cancelled.

In some embodiments, the portion of the set of resource blocks is preconfigured.

In some embodiments, an electronic apparatus for facilitating communication in a wireless network, comprises: a memory; and a processor operably coupled to the memory. The processor is configured to cause: establishing a data path with a wireless communication device; agreeing on a set of resource blocks with the wireless communication device for communication on the data path; receiving, from the wireless communication device, a message indicating when the electronic apparatus cancels a portion of the set of resource blocks; and cancelling the portion of the set of resource blocks for transmitting data on the data path based on the message, wherein the electronic apparatus is refrained from transmitting data to the wireless communication device on the data path during the cancelled portion of the set of resource blocks.

In some embodiments, the message indicates that the wireless communication device cancels the portion of the set of resource blocks when a response to the message is received, and wherein cancelling the portion of the set of resource blocks comprises: cancelling the portion of the set of resource blocks when the response to the message is received.

In some embodiments, the processor is further configured to cause: restoring the cancelled portion of the set of resource blocks when successful data transmission or reception associated with the data path is made.

In some embodiments, the message indicates that the wireless communication device cancels the portion of the set of resource blocks when the data path is inactive in the wireless communication device for a duration, and wherein cancelling the portion of the set of resource blocks comprises: determining that the data path is inactive in the wireless communication device for the duration, and cancelling the portion of the set of resource blocks based on a determination that the data path is inactive in the wireless communication device for the duration.

In some embodiments, determining that the data path is inactive in the wireless communication device for the duration comprises: determining that the data path is inactive in the wireless communication device for the duration when no successful data transmission or reception associated with the data path is made for the duration.

In some embodiments, the message includes a parameter indicating the duration.

In some embodiments, determining that the data path is inactive in the wireless communication device for the duration comprises: determining that the data path is inactive in the wireless communication device for the duration if the duration ends at a time belonging to an active resource block excluding an observation window located at the beginning of the active resource block.

In some embodiments, determining that the data path is inactive in the wireless communication device for the duration comprises: determining that the data path is inactive in the wireless communication device for the duration if the duration ends at a time not belonging to any active resource blocks and if the data path remains inactive during a predetermined time in one or more active resource blocks.

In some embodiments, determining that the data path is inactive in the wireless communication device for the duration comprises: determining that the data path is inactive in the wireless communication device for the duration if the duration ends at a time belonging to an observation window located at the beginning of an active resource block and if the data path remains inactive during a predetermined time in one or more active resource blocks.

### BRIEF DESCRIPTION OF THE DRAWINGS

FIG. 1 shows an example of a wireless network 100 in accordance with an embodiment.

FIG. 2 shows an example of AP 101 in accordance with an embodiment.

FIG. 3 shows an example of STA 111 in accordance with an embodiment.

FIG. 4 shows an exchange for DRX configuration between two NAN devices in accordance with an embodiment.

FIG. 5 shows expiration of an NDP inactivity countdown timer in accordance with an embodiment.

FIG. 6 shows expiration of an NDP inactivity countdown timer in accordance with an embodiment.

FIG. 7 shows expiration of an NDP inactivity countdown timer in accordance with an embodiment.

FIG. 8 shows the operation of two devices based on the explicit signal in accordance with an embodiment.

FIG. 9 shows operations of two devices in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

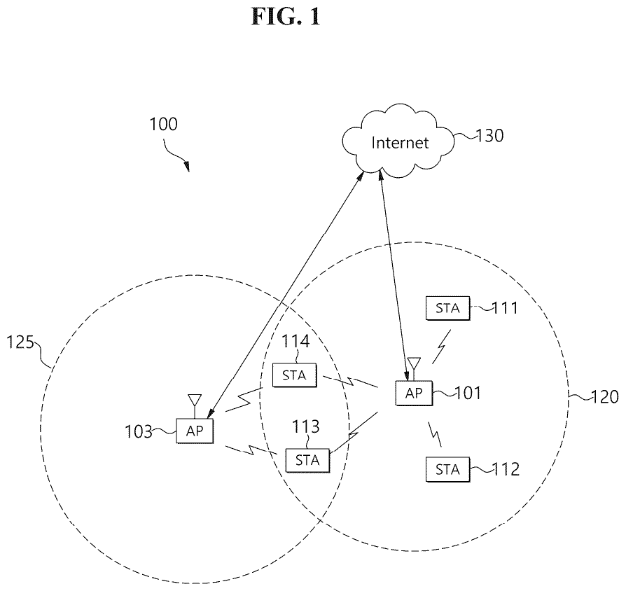

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

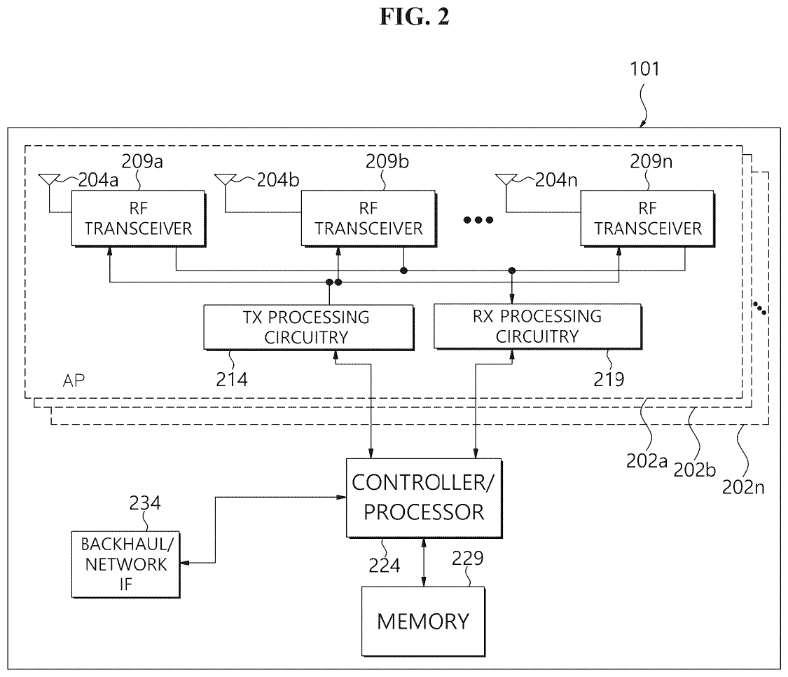

FIG. 2 shows an example of AP 101 in accordance with an embodiment. The embodiment of the AP 101 shown in FIG. 2 is for illustrative purposes, and the AP 103 of FIG. 1 could have the same or similar configuration. However, APs come in a wide range of configurations, and FIG. 2 does not limit the scope of this disclosure to any particular implementation of an AP.

As shown in FIG. 2, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2 illustrates one example of AP 101, various changes may be made to FIG. 2. For example, the AP 101 could include any number of each component shown in FIG. 2. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2 could be combined, further subdivided, or omitted and additional components could be added according to particular needs.

As shown in FIG. 2, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2 shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

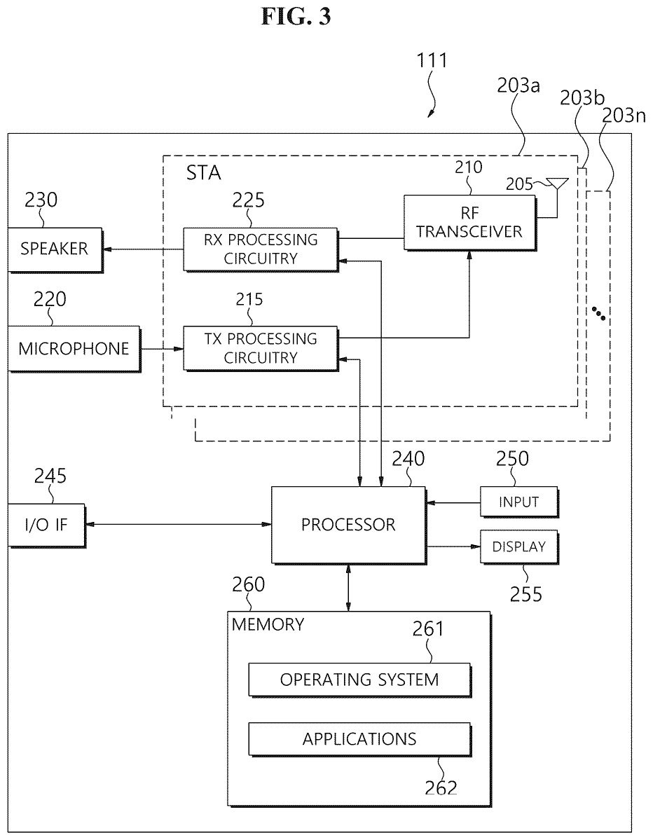

FIG. 3 shows an example of STA 111 in accordance with an embodiment. The embodiment of the STA 111 shown in FIG. 3 is for illustrative purposes, and the STAs 111-114 of FIG. 1 could have the same or similar configuration. However, STAs come in a wide variety of configurations, and FIG. 3 does not limit the scope of this disclosure to any particular implementation of a STA.

As shown in FIG. 3, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 3 shows one example of STA 111, various changes may be made to FIG. 3. For example, various components in FIG. 3 could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

As shown in FIG. 3, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 3 shows that each STA 203a-203n has a separate antenna, but each STA 203a-203n can share the antenna 205 without needing separate antennas. Each STA 203a-203n may represent a physical (PHY) layer and a lower media access control (MAC) layer.

Hereinafter, an approach for the devices to dynamically cancel some NDP CRBs based on NDP inactivity in accordance with various embodiments will be described.

On the canceled CRBs, the NAN devices may abandon listen state and enter doze state, or the NAN devices may heed different channel to perform another concurrent operation. For example, the NAN devices may return to an infrastructure WLAN connection with an AP station.

As NDP PS configuration parameters, a schedule management entity of the NAN device may determine its own PS parameters such as an NDP inactivity countdown timer reset value ndpInactivityTimeout_self and an NDP DRX schedule ndpDrxCrbs_self. The NDP DRX schedule may be referred to as a DRX schedule, a NDP PS schedule, or NDP DRX CRBs. The schedule management entity of the NAN device may receive PS parameters such as NDP inactivity countdown timer reset value ndpInactivityTimeout_peer and an NDP PS or DRX schedule ndpDrxCrbs_peer from the peer NAN device.

In some embodiments, the DRX schedule ndpDrxCrbs_self may be a subset of the original NDP CRBs. For example, the NDP DRX schedule ndpDrxCrbs_self may be obtained by cancelling or deleting some time slots that are part of the original NDP CRBs. The meaning and use of this parameter will be described in greater detail later.

In some embodiments, the NAN device may maintain an NDP inactivity countdown timer with a reset value of ndpInactivityTimeout_self. For convenience, the reset value of a countdown timer will be referred to as a name for the countdown timer. For example, the timer ndpInactivityTimeout_self may refer to a countdown timer of which a reset value is given by the parameter ndpInactivityTimeout_self. This countdown timer ndpInactivityTimeout_self may be used to measure a duration of an inactivity on the NDP. The expiration of the timer ndpInactivityTImeout_self may indicate that the NDP has been inactive for a duration equal to or exceeding time indicated by the parameter ndpInactivityTimeout_self. After the timer ndpInactivityTimeout_self expires, the NAN device may enter a DRX mode based on the NDP DRX schedule ndpDrxCrbs_self. The DRX mode may be referred to alternatively as a power save (PS) mode, a reduced schedule mode. In some embodiments, the value of the parameter ndpInactivityTimeout_self may determine how long the NDP inactivity should last before the NAN device enters into the PS or the DRX mode. In some embodiments, the value of ndpInactivityTimeout_self may be configured in range of 16 time units (TUs) to 2048 TUs. The operation of the timer ndpInactivityTimeout_self and operation of the NAN device in DRX mode will be described in greater detail later.

In some embodiments, the NAN device may determine these DRX parameters ndpInactivityTimeout_self and ndpDrxCrbs_self based on QoS requirements associated with the NDP. In some embodiments, the QoS requirements may be typically provided to the scheduling entity by a higher layer such as service or application layer. In some embodiments, alternatively, the scheduling entity may provide an interface for the higher layer to directly configure these DRX parameters in the NAN device.

In some embodiments, the peer NAN device may send its DRX configuration such as parameters ndpInactivityTimeout_self and ndpDrxCrbs_self to the NAN device on the NDP. Similarly, the NAN device may receive a DRX configuration from the peer NAN device on the NDP. The parameters received from the peer NAN device with a suffix “_peer” will be denoted in place of the suffix “_self” as previously introduced. In some embodiments, the NAN device may record the DRX parameters ndpInactivityTimeout_peer and ndpDrxCrbs_peer received from the peer NAN device.

For example, a MAC entity (also called L2) in the NAN device may maintain the timer ndpInactivityTimeout_self which controls the PS or DRX operation of the NAN device. Moreover, the MAC entity of the NAN device may maintain the timer ndpInactivityTimeout_peer with reset value ndplnactivityTimeout_peer which tracks the DRX state of the peer NAN device. In some embodiments, the timer ndpInactivityTimeout_peer may be described as the NAN device's attempt to replicate the timer ndplnactivityTimeout_self of the peer NAN device.

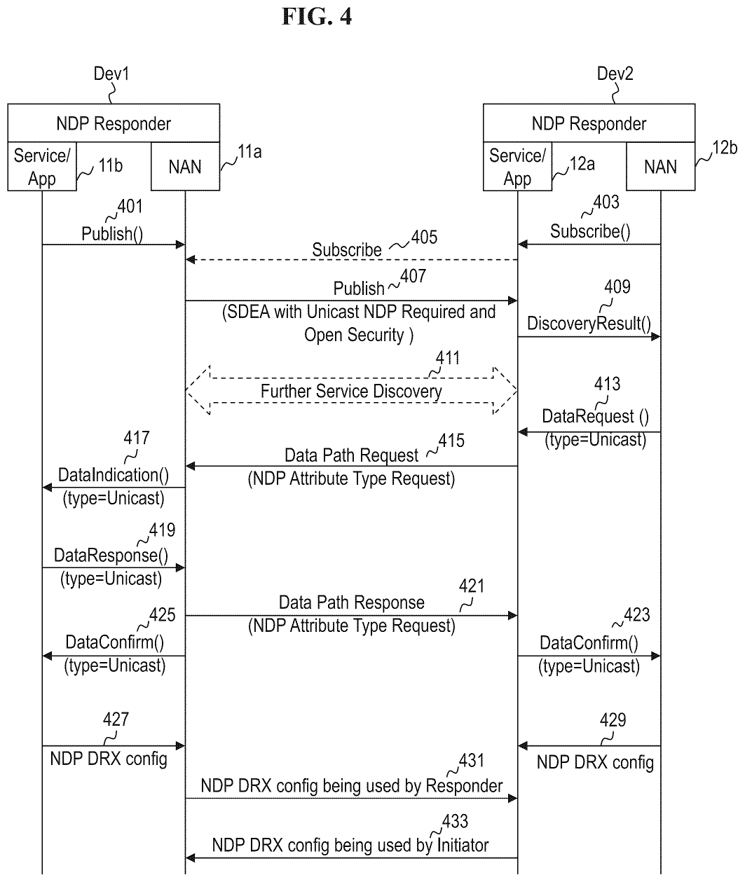

In some embodiments, the NAN device and the peer NAN device may exchange PS or DRX configuration parameters using a vendor-specific information element (VSIE) or a vendor-specific attribute in a NAN Action Frame (NAF). In some embodiments, the DRX parameters may be exchanged after the NDP has been set up and CRBs have been agreed by both devices, as illustrated in FIG. 4. In some embodiments, the DRX configuration parameters may be sent alongside NDP setup messages. In some embodiments, the NDP DRX schedule ndpDrxCrbs_self is sent alongside the NDP CRBs proposal.

Hereinafter, an exchange for DRX configuration between two NAN devices in accordance with an embodiment will be described with reference to FIG. 4.

FIG. 4 shows an exchange for DRX configuration between two NAN devices in accordance with an embodiment.

Referring to FIG. 4, a NAN device Dev1 including a NAN engine 11a and a service/application 11b operates as a NDP responder and a NAN device Dev2 including a NAN engine 12a and a service/application 12b operates as a NDP initiator.

At 401, the service/application 11b of the NAN device Dev1 sends an event publish ( ) to publish its service to the NAN engine 11a.

At 403, the service/application 12b of the NAN device Dev2 sends, to the NAN engine 12a, an event subscribe ( ) to subscribe a service of the service/application 11b of the NAN device Dev1.

At 405, the NAN engine 12a of the NAN device Dev2, to the NAN engine 11a of the NAN device Dev1, transmits a subscribe message to subscribe a service of the service/application 11b of the NAN device Dev1.

At 407, the NAN engine 11a of the NAN device Dev1 transmits a publish message to the NAN engine 12a of the first NAN device 12. In some embodiments, the publish message may be transmitted in response to the subscribe message. In some embodiments, the NAN device Dev1 may transmit the publish message as an unsolicited message without receiving the subscribe message.

At 409, the NAN engine 12a of the NAN device Dev2 sends an event DiscoveryResult( ) to the service/application 12b.

In some embodiments, the NAN device Dev2 may receive the publish message to discover a service.

At 411, the NAN engine 11a of the NAN device Dev1 and the NAN engine 12a of the first NAN device 12 may perform further service discovery.

At 413, the service/application 12b of the NAN device Dev2 sends an event DataRequest( ) to the NAN engine 12a.

At 415, the NAN engine 12a of the NAN device Dev2 transmits a data path request message to the NAN engine 11a of the NAN device Dev1.

At 417, the NAN engine 11a of the second NAN device 11 sends an event DataResponse( ) to the service/application 11b.

At 419, the service/application 11b of the NAN device Dev1 sends an event DataConfirm( ) to the NAN engine 11a.

At 421, the NAN engine 11a of the NAN device Dev1 transmits a data path response message to the NAN engine 12a of the first NAN device 12.

At 423, the NAN engine 12a of the NAN device Dev2 sends an event DataConfirm( ) to the service/application 12b.

At 425, the NAN engine 11a of the second NAN device 11 sends an event DataConfirm( ) to the service/application 11b.

In some embodiments, the NAN device Dev1 and the NAN device Dev2 may establish a NDP and agree a set of CRBs for communication on the NDP.

At 427, the service/application 11b of the NAN device Dev1 sends an event including NDP DRX configuration of the NAN device Dev1 to the NAN engine 11a.

At 429, the service/application 12b of the NAN device Dev2 sends an event including NDP DRX configuration of the NAN device Dev2 to the NAN engine 12a.

At 431, the NAN engine 11a of the NAN device Dev1 transmits a message including NDP DRX configuration of the NAN device Dev1 to the NAN engine 12a of the first NAN device 12. In some embodiments, the NDP DRX configuration of the NAN device Dev1 may include at least one of an NDP inactivity countdown timer reset value and an NDP DRX schedule of the NAN device Dev1.

At 433, the NAN engine 12a of the NAN device Dev2 transmits a message including NDP DRX configuration of the NAN device Dev2 to the NAN engine 11a of the NAN device Dev1. In some embodiments, the NDP DRX configuration of the second device 12 may include at least one of an NDP inactivity countdown timer reset value and an NDP DRX schedule of the NAN device Dev2.

As shown in FIG. 4, the NAN device Dev1 and the NAN device Dev2 have an NDP connection between them. Therefore, the NAN device Dev1 and the NAN device Dev2 have an NDP schedule comprising CRBs where the two NAN devices Dev1 and Dev2 may communicate with each other. In some embodiments, agreed-upon time and channel resources may be referred to as the CRBs.

Hereinafter, operation of NDP inactivity countdown timers in accordance with various embodiments will be described.

The MAC entity in the NAN device may reset the NDP inactivity countdown timers associated with an NDP. For example, the NAN device may reset timers ndpInactivityTimeout_self and ndplnactivityTimeout_peer, at each successful transmission or reception on the NDP. In some embodiments, the NAN device may reset a countdown timer by loading the countdown timer with its reset value equal to, but not limited to, the value of the parameter ndpInactivityTimeout_self and starting countdown of the timer.

In some embodiments, the NAN device may determine a successful transmission or reception when the MAC entity in the NAN device transmits an acknowledgement (ACK) frame for a frame received from the NAN Data Interface address (NDI) of the peer NAN device, for example, but not limited to, during the NDP CRBs. In some embodiments, the time instant at which the NAN device determines a successful reception of a frame may be more precisely defined as the time stamp of a primitive PHY-TXEND.confirm associated with the transmission of the ACK frame, as reported by PHY layer.

In some embodiments, the NAN device may determine a successful transmission or reception, when the NAN device receives an ACK frame for a frame transmitted to the NDI of the peer NAN device, for example, but not limited to, during the NDP CRBs. In some embodiments, the time instant may be more precisely defined as the time stamp of a primitive PHY-RXEND.indication associated with the reception of the ACK frame, as reported by PHY layer.

Certain frames may be ignored for the purpose of resetting NDP inactivity countdown timers. For example, a frame sent for Keep-Alive (KA) purposes may be ignored. In some embodiments, the NDP inactivity timers may not be reset based on KA frames. In some embodiments, the KA frames may be sent by the MAC layer instead of the application layer. In some embodiments, the KA frames may not contain application-layer data. In some embodiments, the purpose of the KA frames may be to prevent NDP termination due to inactivity. In some embodiments, a Null data frames may also be ignored for the purpose of resetting NDP inactivity countdown timers.

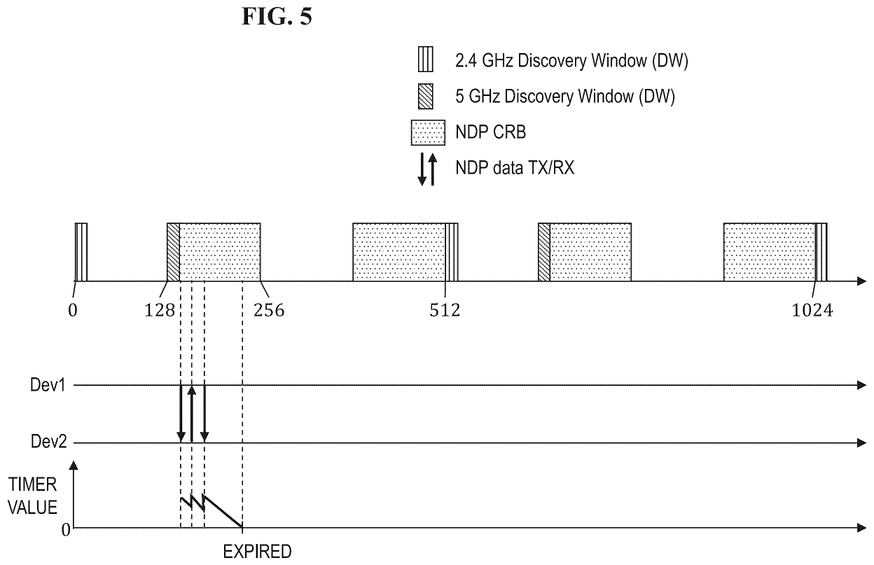

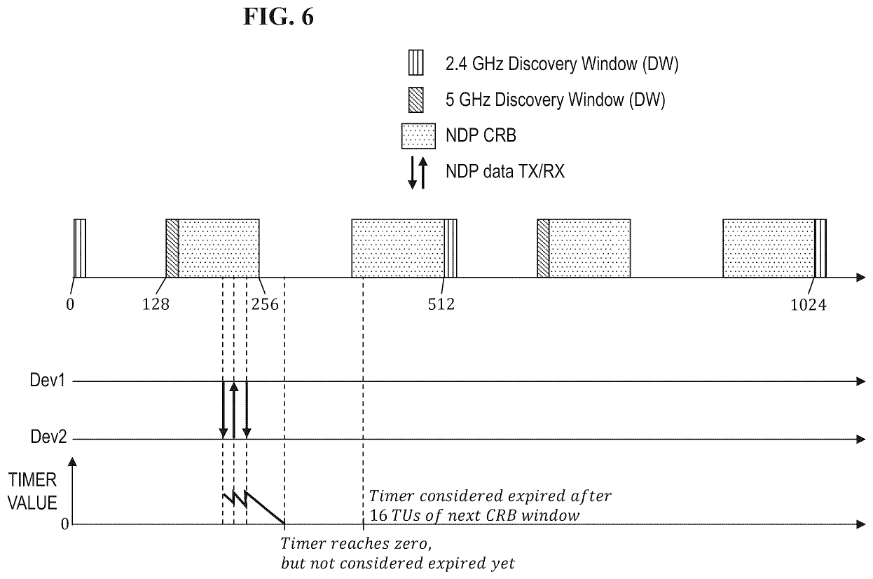

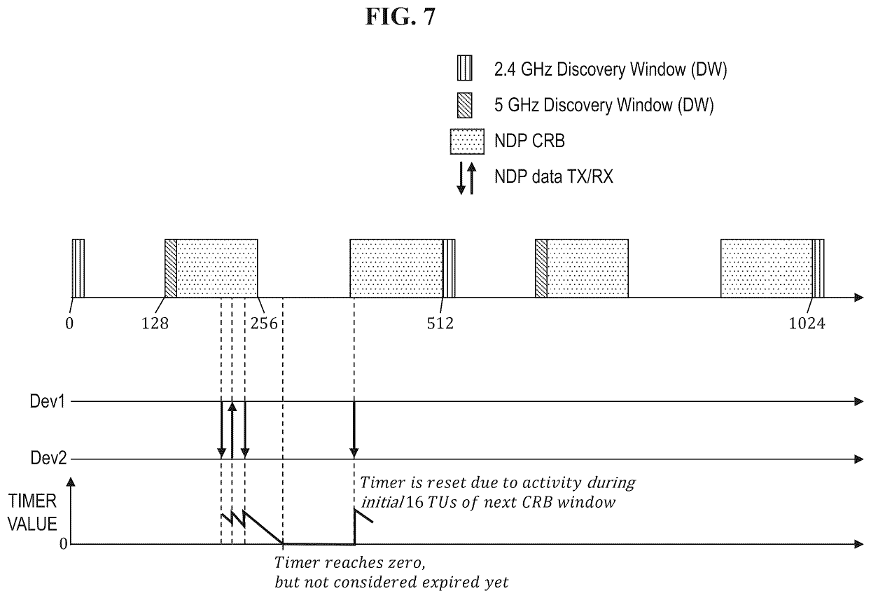

Hereinafter, a procedure for determining the expiration of NDP inactivity countdown timers in accordance with various embodiments will be described with reference to FIG. 5, FIG. 6, and FIG. 7.

FIG. 5 shows expiration of an NDP inactivity countdown timer in accordance with an embodiment.

In some embodiments, an NDP inactivity countdown timer may be considered expired if the value of the timer reaches zero. In some embodiments, as shown in FIG. 5, the NDP inactivity countdown timer may be considered expired if the value of the timer reaches zero during a NDP CRB and after an initial observation window (OW) of the current CRB. In some embodiments, the duration of the initial OW may be a fixed or pre-configured value. For example, the duration of the initial OW may be equal to 16 TUs. In some embodiments, the duration of the OW may be derived or determined based on the duration of the current CRB. In some embodiments, setting OW to zero may be equivalent to having no OW-related condition required for determining the expiration of the countdown timer. If OW is larger than 0, it may be advantageous when the peer NAN device may have data in the buffer to transmit to the device at a time which does not belong to NDP CRBs. For example, that service or app layer may place data in the peer NAN device's MAC buffer at a time when there were no CRBs available to transmit this data. Therefore, as soon as the next CRB starts, the peer NAN device may attempt to acquire the channel and transmit the data on the NDP. The OW being greater than 0 may give the peer NAN device an opportunity to transmit data at the start of the CRB. If the peer NAN device does not still transmit anything and thus the inactivity timer expired after an initial OW of the current CRB, it may be concluded with greater certainty that the peer indeed does not have any data and the NDP thus remain inactive for lack of data. Therefore, inactivity timer expiration after an OW may mean that the NDP has been inactive for a duration indicated by the inactivity timer.

Hereinafter, an inactivity timer reaching zero during an initial OW duration of a CRB or reaching zero outside of CRBs will be described with reference to FIG. 6.

FIG. 6 shows expiration of an NDP inactivity countdown timer in accordance with an embodiment.

In some embodiments, the timer may not be considered expired during the initial OW of the current CRB if the timer reaches zero during the initial OW of the current CRB. In some embodiments, the timer may not be considered expired during the initial OW of the next CRB if the timer reaches zero at a time which does not belong to any CRBs. In some embodiments, the timer may be considered expired at the end of the OW, or when total time equal to the OW elapses during one or more CRBs since the timer reaches zero, whichever occurs first, if the timer is not reset during the OW-long transmission opportunity and the timer remains at zero.

For example, if the timer reaches zero outside of any NDP CRBs, the NAN device may not immediately consider that the timer expired and may continue to monitor another OW during subsequent NDP CRB. If there is no NDP activity that resets the inactivity timer during the OW, the inactivity timer may be considered expired at the end of the OW.

Hereinafter, an inactivity timer reaching zero outside of CRBs in accordance with another embodiment will be described with reference to FIG. 7.

FIG. 7 shows expiration of an NDP inactivity countdown timer in accordance with an embodiment.

Referring to 7, if the inactivity countdown timer reaches zero outside of CRBs, the NAN device may not immediately consider that the timer expired, may still monitor subsequent NDP CRBs for another OW, and may reset the timer after detecting activity on the NDP during the OW before it could be considered expired.

As described above, the inactivity countdown timers may run down as natural and reach zero, but additional conditions for considering that the timers expired may be required in addition to the timers reaching zero. Alternatively, the countdown timers may be allowed to run down naturally until they reach a value equal to the duration of the OW, additional conditions for making the timers able to continue running down below the value of the OW may be required, and the inactivity timers reaching zero may be considered as expired. For example, when the value of an NDP inactivity countdown timer is less than or equal to the duration of the OW, the timer may be required to run only during NDP CRBs and may be paused outside of NDP CRBs.

Hereinafter, operations of the NAN device in DRX mode will be described. In particular, a procedure for determining an NDP schedule after the NDP inactivity timer expires will be described.

After the timer ndpInactivityTimeout_self expires and is not running, the NAN device may enter the DRX mode. The DRX mode may be referred to alternatively as a power save (PS) mode, a reduced schedule mode, or a doze state. After the timer ndpInactivityTimeout_peer expires and is not running, the NAN device may be required to assume that the peer enters DRX mode.

After the timer ndpInactivityTimeout_self expires and is not running, the NAN device may assume that the peer NAN device will transmit data on NDP to the NAN device during CRBs included in the NDP DRX schedule ndpDrxCrbs_self. For example, the NAN device may assume that the peer NAN device will transmit data on NDP to the NAN device only during CRBs included in the NDP DRX schedule ndpDrxCrbs_self. As described above, the DRX schedule ndpDrxCrbs_self may be a subset of the original NDP CRBs and may be obtained by cancelling or deleting some time slots that are part of the original NDP CRBs. Since the NAN device does not expect to receive any data from the peer NAN device outside of the NDP DRX schedule ndpDrxCrbs_self, the NAN device may enter a doze state outside of the NDP DRX schedule ndpDrxCrbs_self or heed different channel to perform another WLAN operation. For example, the NAN devices may return to a different channel to connect an WLAN infrastructure associated with an AP station and may communicate with the AP on the different channel.

After the timer ndpInactivityTimeout_peer expires and is not running, the NAN device may be required to transmit frames to the peer NAN device on NDP during (e.g., only during) the DRX schedule ndpDrxCrbs_peer. Some frames such as the ACK frame, the NACK frame, or the Block Ack (BA) frame may be exempt from this restriction, as these are transmitted in response to a frame received from the peer NAN device. For example, the NAN device may be required to assume the peer NAN device is in doze state outside the DRX schedule ndpDrxCrbs_peer for the purpose of transmitting frames on the NDP to the peer NAN device.

In some embodiments, the data transmission may be permitted differently the data reception when the NAN device is in DRX mode after an NDP inactivity timer expires and is not running. In some embodiments, the expiration of the timer ndpInactivityTimeout_self may have no bearing on when the NAN device can transmit data to the peer NAN device. For example, when the NAN device is in the DRX mode because of the expiration of the timer ndpInactivityTimeout_self and the NAN device has data in the MAC egress buffer, the NAN device may come out of the dose state if the NAN device is in the dose state. And then, the NAN device may transmit data to the peer NAN device on original NDP CRBs if the timer ndpInactivityTimeout_peer is running, assuming that the peer NAN device is not in the DRX mode. the NAN device may transmit data to the peer NAN device on the DRX schedule ndpDrxCrbs_peer if the peer NAN device is in the DRX mode.

Above described above, the NAN device with an NDP may operate in normal mode or in DRX mode based on the NDP inactivity. In some embodiments, the DRX mode may have further stages. For example, the DRA mode may have a first stage with schedule determined by a parameter ndpDrxCrbs_stage1 self and a second stage with schedule determined by a parameter ndpDrxCrbs_stage2 self. In some embodiments, the NAN device may run an inactivity countdown timer associated with each DRX stage. The expiration of the timer associated with a DRX stage may determine when the associated DRX stage commences. These timers ndpDrxCrbs_stage1_self and ndpDrxCrbs_stage2 self may run in parallel, or one timer may run after another timer expires.

In some embodiments, the NDP DRX schedule DRX schedule ndpDrxCrbs_self may be derived from NDP CRBs implicitly, based on preconfigured rules. In these scenarios, the NAN device may not need to send the parameter to the peer NAN device as the peer NAN device could also derive it on its own without the parameter. For example, the NDP DRX schedule ndpDrxCrbs_self may be set equal to the NAN Data Cluster (NDC) CRBs. In some embodiments, the resources that all member devices of an NDC can be required to be present on may be referred to as the NDC CRBs.

When the timer ndpInactivityTimeout_self expires, the NAN device enters the DRX mode. If the NAN device is in the DRX mode and detects successful transmission or reception on the NDP, the NAN device may resume activity on NDP, may reset the inactivity timer ndpInactivityTimeout_self, may exit the DRX mode, and may resume the normal NDP schedule having no canceled CRBs. The normal NDP schedule may be referred to as a full NDP schedule. When the timer ndpInactivityTimeout_peer expires, the NAN device may determine that the peer NAN device enters the DRX mode. If the NAN device determines that the peer NAN device in the DRX mode and detects successful transmission or reception on the NDP, the NAN device may resume activity on NDP, may reset the inactivity timer ndpInactivityTimeout_peer, may assume that the peer NAN device exits the DRX mode, and may resume the normal NDP schedule. Alternatively, the exit from the DRX mode may be determined only based on successful reception of data on the NDP.

Hereinafter, an explicit signal to indicate the start of the DRX mode in accordance with various embodiments will be described.

As described above, a NAN device may start operating in the DRX mode at the expiry of the timer ndpInactivityTimeout_self and the NAN device may determine that its peer NAN device enters the DRX mode based on the expiry of the timer ndpInactivityTimeout_peer. In some embodiments, the NAN device may explicitly indicate to the peer NAN device that the NAN device is entering the DRX mode. In some embodiments, the NAN device may explicitly indicate to the peer NAN device that the NAN device assumes that the peer NAN device enters the DRX mode. In some embodiments, the NAN device may explicitly indicate to the peer NAN device that the NAN device permits the peer NAN device to enter the DRX mode.

For example, the NAN device may send to the peer NAN device a data frame with the power management (PM) bit or the end of service period (EOSP) bit set equal to 1 in the MAC header, to indicate to the peer NAN device that the NAN device starts the DRX mode. Alternatively, the NAN device may send to the peer NAN device an Action frame or a Management frame to indicate to the peer NAN device that the NAN device starts the DRX mode. In some embodiments, the NAN device may enter the DRX mode upon receiving an Ack in response to the Action frame, the Management frame, or the data frame indicating the start of the DRX mode. In some embodiments, the NAN device may use the PM bit or the EOSP bit in a Null Data Frame to indicate the start of the DRX mode. The NAN device may exit the DRX mode upon successful reception or transmission associated with the NDP. A message that indicates the start of DRX mode may be ignored for the purpose of resuming the normal NDP schedule or for maintaining or resetting the NDP inactivity timer. For example, the inactivity timer may not be reset upon reception or transmission of a message that indicates the start of the DRX mode.

When a NAN device receives an indication from a peer NAN device that the peer NAN device is entering DRX mode, the NAN device may assume that the peer NAN device enters DRX mode. Therefore, as described earlier, the NAN device may be required to assume the peer NAN device is listening only during the DRX schedule ndpDrxCrbs_peer and thus the NAN device may transmit frame to the peer NAN device on this NDP only during the DRX schedule ndpDrxCrbs_peer. Upon successful transmission or reception associated with the NDP, the NAN device may assume that the peer NAN device exits the DRX mode and resumes the normal NDP schedule.

The NAN device may indicate the start of the DRX mode based on at least one of an inactivity timer such as the timer ndpInactivityTimeout_self, an indication from Application layer to start the DRX mode, and a duration for which a MAC buffer associated with the NDP has been empty. The MAC layer at the NAN device may provide an interface to the application layer through which the application layer can command the MAC layer to send the DRX mode start indication to the peer NAN device. If there is any data in MAC buffer associated with the NDP, the NAN device may finish transmitting the data and empty the queue before indicating the start of DRX mode.

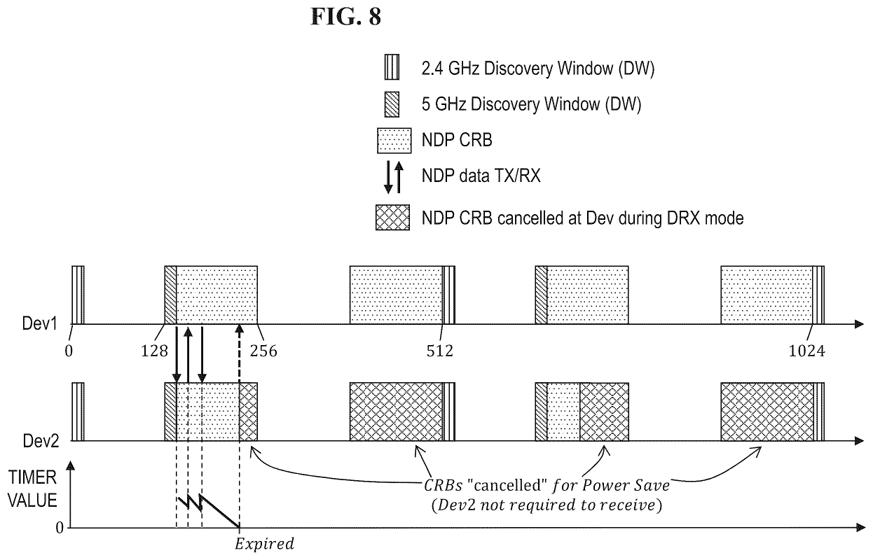

FIG. 8 shows the operation of two devices based on the explicit signal in accordance with an embodiment.

In FIG. 8, two NAN devices Dev1 and Dev2 are involved. The NAN device Dev2 monitors the timer ndpInactivityTimeout_self to check if the timer expires. If the NAN device Dev2 determines that the timer ndpInactivityTimeout_self expires, the NAN device Dev2 may explicitly indicate the start of its DRX mode and subsequently enter the DRX mode by cancelling a portion of the original NDP schedule for Listen purposes.

In some embodiments, when the NAN device Dev2 sends a message including an explicit indication to indicate that the NAN device Dev2 intends to enter the DRX mode, the peer NAN device Dev1 may be allowed to accept or reject this request. In some embodiment, the NAN device Dev1 may not be given the authority to reject and the NAN device Dev1 may be required to merely send an acknowledgement to the message if the NAN device Dev1 correctly decodes the message. Upon receiving the ack, the NAN device Dev2 may enter the DRX mode.

In some embodiments, the NAN device Dev2 may wait a certain time duration or a time window before the NAN device Dev2 enters the DRX mode. If the NAN device Dev2 receives or transmits on NDP during the time window, it may cancel the entry of the DRX mode. In some embodiments, if the device Dev1 receives or transmits on NDP during the time window, the device Dev1 may assume that the NAN device Dev2 cancelled the DRX mode.

Upon entering the DRX mode, the NAN device Dev2 may cancel a portion of the original NDP schedule in that the NAN device Dev2 stops listening for NDP associated transmissions from the NAN device Dev1 on the canceled resources. The NAN device Dev2 may continue to listen as usual on the resources indicated by the NDP DRX schedule ndpDrxCrbs_self. In some embodiments, if the NAN device Dev1 needs to transmit data on the NDP to the NAN device Dev2, the NAN device Dev1 may transmit data during the resources indicated by the DRX schedule ndpDrxCrbs_peer because the resources indicated by the DRX schedule ndpDrxCrbs_peer in the original NDP schedule have not been cancelled by the NAN device Dev2. Even though the NAN device Dev1 does not transmit to the NAN device Dev2 on the cancelled resources, the NAN device Dev1 nevertheless may continue to listen for the NAN device Dev2 on those canceled resources as well as the full NDP schedule because the NAN device Dev1 itself has not entered its own DRX.

In some embodiments, the EOSP bit may be used to convey that the NAN device is assuming or permitting the peer NAN device to enter the DRX mode, instead of conveying the start of the DRX mode at the NAN device itself.

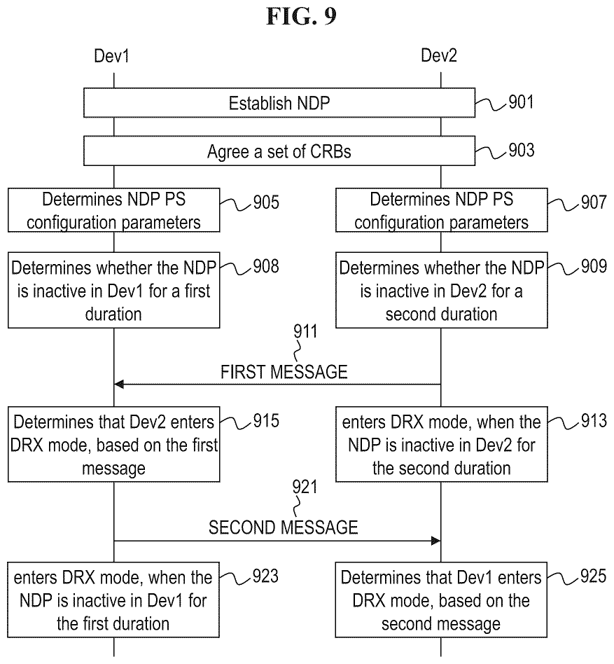

FIG. 9 shows operations of two devices in accordance with an embodiment.

At 901, the NAN device Dev1 and the NAN device Dev2 establish a Neighborhood Aware Networking (NAN) data path (NDP).

At 903, the NAN device Dev1 and the NAN device Dev2 agree on a set of CRBs to be used for communication on the NDP.

At 905, the NAN device Dev1 determines NDP PS configuration parameters ndpInactivityTimeout_self_1 and ndpDrxCrbs_self_1 for the NAN device Dev1. In some embodiments, the NDP PS configuration parameter ndpInactivityTimeout_self_1 may be used to reset a first timer which determines the NDP inactivity of the NAN device Dev1. In some embodiments, the NDP PS configuration parameter ndpDrxCrbs_self_1 may indicate a cancelled portion of the set of CRBs when the NAN device Dev1 is in the DRX mode.

At 907, the NAN device Dev2 determines NDP PS configuration parameters ndpInactivityTimeout_self_2 and ndpDrxCrbs_self_2 for the NAN device Dev2. In some embodiments, the NDP PS configuration parameter ndplnactivityTimeout_self_2 may be used to reset a second timer which determines the NDP inactivity of the NAN device Dev2. In some embodiments, the NDP PS configuration parameter ndpDrxCrbs_self_2 may indicate a cancelled portion of the set of CRBs when the NAN device Dev2 is in the DRX mode.

In some embodiments, the NDP PS configuration parameter ndpInactivityTimeout_self_2 may be equal to or different from the NDP PS configuration parameter ndpInactivityTimeout_self_1. In some embodiments, the NDP PS configuration parameter ndpDrxCrbs_self_2 may be equal to or different from the NDP PS configuration parameter ndpDrxCrbs_self_1.

At 908, the NAN device Dev1 determines whether the NDP is inactive in the NAN device Dev1 for a first duration. In some embodiments, the NDP PS configuration parameter ndpInactivityTimeout_self_1 may indicate the first duration and the lapse of the first duration may be measured by the first timer. In some embodiments, the NAN device Dev1 may determine that the NDP is inactive in the NAN device Dev1 for the first duration when the NAN device Dev1 has made no successful data transmission or reception for the first duration.

At 909, the NAN device Dev2 determines whether the NDP is inactive in the NAN device Dev2 for a second duration. In some embodiments, the NDP PS configuration parameter ndpInactivityTimeout_self_2 may indicate the second duration and the lapse of the second duration may be measured by the second timer. In some embodiments, the NAN device Dev2 may determine that the NDP is inactive in the NAN device Dev2 for the second duration when the NAN device Dev2 has made no successful data transmission or reception for the second duration.

At 911, the NAN device Dev2 transmits, to the NAN device Dev1, a first message indicating when the NAN device Dev2 enters the DRX mode. In some embodiments, the first message may indicate that the NAN device Dev2 enters the DRX mode when the NAN device Dev2 receives an ACK frame in response to the first message. In some embodiments, the first message may explicitly indicate that the NAN device Dev2 immediately enters the DRX mode. In some embodiments, the first message may indicate that the NAN device Dev2 enters the DRX mode when the NDP is inactive in the NAN device Dev2 for the second duration. In those embodiments, the first message may be sent before operation 909 and after operation 907. In some embodiments, the first message may include the NDP PS configuration parameter ndpInactivityTimeout_self_2, NDP PS configuration parameterndpDrxCrbs_self_2, or both. In those embodiments, the first message may be sent before operation 909 and after operation 907.

At 913, the NAN device Dev2 enters the DRX mode when the NAN device Dev2 determines that the NDP is inactive in the NAN device Dev2 for the second duration. In some embodiments, the NAN device Dev2 may transmit the first message when the NAN device Dev2 determines that the NDP is inactive in the NAN device Dev2 for the second duration and the NAN device Dev2 may immediately enter the DRX mode. In some embodiments, the NAN device Dev2 may transmit the first message when the NAN device Dev2 determines that the NDP is inactive in the NAN device Dev2 for the second duration and the NAN device Dev2 may enter the DRX mode when the NAN device Dev2 receives an ACK frame in response to the first message. In some embodiments, after the NAN device Dev2 transmits the first message, the NAN device Dev2 may continue to monitor whether the NDP is inactive in the NAN device Dev2 for the second duration. In some embodiments, the NAN device Dev2 may determine that the NDP is inactive in the NAN device Dev2 for the second duration if the second duration ends at a time belonging to an active CRB excluding an observation window (OW) located at the beginning of the active CRB. In some embodiments, the NAN device Dev2 may determine that the NDP is inactive in the NAN device Dev2 for the second duration if the second duration ends at a time not belonging to any active CRBs and if the NDP remains inactive during a predetermined time in one or more active CRBs. In some embodiments, the NAN device Dev2 may determine that the NDP is inactive in the NAN device Dev2 for the second duration if the second duration ends at a time belonging to an observation window located at the beginning of an active CRB and if the NDP remains inactive during a predetermined time in one or more active CRBs. In some embodiments, the predetermined time may be equal to the OW. In some embodiments, the NAN device Dev2 may determine that the NDP is inactive in the NAN device Dev2 for the second duration, based on a timer which is reset with a reset value indicated by the NDP PS configuration parameter ndpInactivityTimeout_self_2. In some embodiments, the NAN device Dev2 may cancel the portion of the set of CRBs indicated by the NDP PS configuration parameter ndpDrxCrbs_self_2 for receiving data on the NDP if the NAN device Dev2 enters the DRX mode. In some embodiments, the NAN device Dev2 may be allowed not to listen on the NDP during the cancelled portion of the set of CRBs.

In some embodiments, the NAN device Dev2 may exit the DRX mode when the NAN device Dev2 determines that the NDP becomes active in the NAN device Dev2. When the NAN device Dev2 exits the DRX mode, the NAN device Dev2 may restore the cancelled portion of the set of CRBs and may be required to listen on the NDP during the set of CRBs. In some embodiments, the NAN device Dev2 may determine that the NDP becomes active in the NAN device Dev2 when the NAN device Dev2 determines that the NAN device Dev2 has made successful data transmission or reception on the NDP. In some embodiments, the NAN device Dev2 may determine that the NAN device Dev2 has made successful data transmission on the NDP when the NAN device Dev2 transmits a data frame to the NAN device Dev1 and receives an ACK frame in response to the data frame from the NAN device Dev1. In some embodiments, the NAN device Dev2 may determine that the NAN device Dev2 has made successful data reception on the NDP when the NAN device Dev2 receives a data frame from the NAN device Dev1 and transmit an ACK frame in response to the data frame to the NAN device Dev1.

At 915, the NAN device Dev1 may determine that the NAN device Dev2 enters the DRX mode based on the first message. In some embodiments, the NAN device Dev1 may determine that the NAN device Dev2 immediately enters the DRX mode when transmitting the first message. In some embodiments, the NAN device Dev1 may determine that the NAN device Dev2 enters the DRX mode when the NAN device Dev1 transmits an ACK frame in response to the first message. In some embodiments, the NAN device Dev1 may determine that the NAN device Dev2 enters the DRX mode when the NDP is inactive for the second duration. In some embodiments, the NAN device Dev1 may determine that the NDP is inactive for the second duration if the second duration ends at a time belonging to an active CRB excluding an observation window (OW) located at the beginning of the active CRB. In some embodiments, the NAN device Dev1 may determine that the NDP is inactive for the second duration if the second duration ends at a time not belonging to any active CRBs and if the NDP remains inactive during a predetermined time in one or more active CRBs. In some embodiments, the NAN device Dev1 may determine that the NDP is inactive for the second duration if the second duration ends at a time belonging to an observation window located at the beginning of an active CRB and if the NDP remains inactive during a predetermined time in one or more active CRBs. In some embodiments, the predetermined time may be equal to the OW. In some embodiments, as described above, the NAN device Dev1 may determine that the NDP is inactive for the second duration, based on a timer which is reset with a reset value indicated by the NDP PS configuration parameter ndpInactivityTimeout_peer_1. The NDP PS configuration parameter ndpInactivityTimeout_peer_1 may be set equal to the received NDP PS configuration parameter ndpInactivityTimeout_self_2. The NDP PS configuration parameter ndpInactivityTimeout_peer_1 may be preconfigured. In some embodiments, the NAN device Dev1 may cancel the portion of the set of CRBs indicated by the NDP PS configuration parameter ndpDrxCrbs_peer_1 for transmitting data on the NDP if the NAN device Dev2 enters the DRX mode. The NDP PS configuration parameter ndpDrxCrbs_peer_1 may be set equal to the received NDP PS configuration parameter ndpDrxCrbs_self_2. The NDP PS configuration parameter ndpDrxCrbs_peer_1 may be preconfigured. In some embodiments, the NAN device Dev1 may be refrained from transmitting data to the NAN device Dev2 on the NDP during the cancelled portion of the set of CRBs.

In some embodiments, the NAN device Dev1 may determine that the NAN device Dev2 exits the DRX mode when the NAN device Dev1 determines that the NDP becomes active. When the NAN device Dev2 exits the DRX mode, the NAN device Dev1 may restore the cancelled portion of the set of CRBs and may be allowed to transmit data to the NAN device Dev2 on the NDP during the set of CRBs. In some embodiments, the NAN device Dev1 may determine that the NDP becomes active when the NAN device Dev1 determines that the NAN device Dev1 has made successful data transmission or reception on the NDP. In some embodiments, the NAN device Dev1 may determine that the NAN device Dev1 has made successful data transmission on the NDP when the NAN device Dev1 transmits a data frame to the NAN device Dev2 and receives an ACK frame in response to the data frame from the NAN device Dev2. In some embodiments, the NAN device Dev1 may determine that the NAN device Dev1 has made successful data reception on the NDP when the NAN device Dev1 receives a data frame from the NAN device Dev2 and transmits an ACK frame in response to the data frame to the NAN device Dev2.

In some embodiments, the NAN device Dev1 may determine that the NAN device Dev2 exits the DRX mode when the NAN device Dev1 determines that the NDP becomes active in the NAN device Dev2. When the NAN device Dev2 exits the DRX mode, the NAN device Dev1 may restore the cancelled portion of the set of CRBs and may be allowed to transmit data to the NAN device Dev2 on the NDP during the set of CRBs. In some embodiments, the NAN device Dev1 may determine that the NDP becomes active in the NAN device Dev2 when the NAN device Dev1 determines that the NAN device Dev2 has made successful data transmission or reception on the NDP. In some embodiments, the NAN device Dev1 may determine that the NAN device Dev2 has made successful data transmission on the NDP when the NAN device Dev1 receives a data frame from the NAN device Dev2 and transmits an ACK frame in response to the data frame to the NAN device Dev2. In some embodiments, the NAN device Dev1 may determine that the NAN device Dev2 has made successful data reception on the NDP when the NAN device Dev1 transmits a data frame to the NAN device Dev2 and receives an ACK frame in response to the data frame from the NAN device Dev2.

At 921, the NAN device Dev1 transmits, to the NAN device Dev2, a second message indicating when the NAN device Dev1 enters the DRX mode. In some embodiments, the second message may explicitly indicate that the NAN device Dev1 immediately enters the DRX mode. In some embodiments, the second message may indicate that the NAN device Dev1 enters the DRX mode when the NAN device Dev1 receives an ACK frame in response to the second message. In some embodiments, the second message may indicate that the NAN device Dev1 enters the DRX mode when the NDP is inactive in the NAN device Dev1 for the first duration. In those embodiments, the first message may be sent before operation 908 and after operation 905. In some embodiments, the second message may include the NDP PS configuration parameter ndpInactivityTimeout_self_1, the NDP PS configuration parameter ndpDrxCrbs_self_1, or both. In those embodiments, the first message may be sent before operation 908 and after operation 905.

At 923, the NAN device Dev1 enters the DRX mode when the NAN device Dev1 determines that the NDP is inactive in the NAN device Dev1 for the first duration. In some embodiments, the NAN device Dev1 may transmit the second message when the NAN device Dev1 determines that the NDP is inactive in the NAN device Dev1 for the first duration and the NAN device Dev1 may immediately enter the DRX mode. In some embodiments, the NAN device Dev1 may transmit the second message when the NAN device Dev1 determines that the NDP is inactive in the NAN device Dev1 for the first duration and the NAN device Dev1 may enter the DRX mode when the NAN device Dev1 receives an ACK frame in response to the second message. In some embodiments, after the NAN device Dev1 transmits the first message, the NAN device Dev1 may continue to monitor whether the NDP is inactive in the NAN device Dev1 for the first duration. In some embodiments, the NAN device Dev1 may determine that the NDP is inactive in the NAN device Dev1 for the first duration if the first duration ends at a time belonging to an active CRB excluding an observation window (OW) located at the beginning of the active CRB. In some embodiments, the NAN device Dev1 may determine that the NDP is inactive in the NAN device Dev1 for the first duration if the first duration ends at a time not belonging to any active CRBs and if the NDP remains inactive during a predetermined time in one or more active CRBs. In some embodiments, the NAN device Dev1 may determine that the NDP is inactive in the NAN device Dev1 for the first duration if the first duration ends at a time belonging to an observation window located at the beginning of an active CRB and if the NDP remains inactive during a predetermined time in one or more active CRBs. In some embodiments, the predetermined time may be equal to the OW. In some embodiments, the NAN device Dev1 may determine that the NDP is inactive in the NAN device Dev1 for the first duration, based on a timer which is reset with a reset value indicated by the NDP PS configuration parameter ndpInactivityTimeout_self_1. In some embodiments, the NAN device Dev1 may cancel the portion of the set of CRBs indicated by the NDP PS configuration parameter ndpDrxCrbs_self_1 for receiving data on the NDP if the NAN device Dev1 enters the DRX mode. In some embodiments, the NAN device Dev1 may be allowed not to listen on the NDP during the cancelled portion of the set of CRBs.

In some embodiments, the NAN device Dev1 may exit the DRX mode when the NAN device Dev1 determines that the NDP becomes active in the NAN device Dev1. When the NAN device Dev1 exits the DRX mode, the NAN device Dev1 may restore the cancelled portion of the set of CRBs and may be required to listen on the NDP during the set of CRBs. In some embodiments, the NAN device Dev1 may determine that the NDP becomes active in the NAN device Dev1 when the NAN device Dev1 determines that the NAN device Dev1 has made successful data transmission or reception on the NDP. In some embodiments, the NAN device Dev1 may determine that the NAN device Dev1 has made successful data transmission on the NDP when the NAN device Dev1 transmits a data frame to the NAN device Dev2 and receives an ACK frame in response to the data frame from the NAN device Dev2. In some embodiments, the NAN device Dev1 may determine that the NAN device Dev1 has made successful data reception on the NDP when the NAN device Dev1 receives a data frame from the NAN device Dev2 and transmit an ACK frame in response to the data frame to the NAN device Dev2.

At 925, the NAN device Dev2 may determine that the NAN device Dev1 enters the DRX mode based on the second message. In some embodiments, the NAN device Dev2 may determine that the NAN device Dev1 immediately enters the DRX mode when transmitting the second message. In some embodiments, the NAN device Dev2 may determine that the NAN device Dev1 enters the DRX mode when the NAN device Dev2 transmits an ACK frame in response to the second message. In some embodiments, the NAN device Dev2 may determine that the NAN device Dev1 enters the DRX mode when the NDP is inactive for the first duration. In some embodiments, the NAN device Dev2 may determine that the NDP is inactive for the first duration if the first duration ends at a time belonging to an active CRB excluding an observation window (OW) located at the beginning of the active CRB. In some embodiments, the NAN device Dev2 may determine that the NDP is inactive for the first duration if the first duration ends at a time not belonging to any active CRBs and if the NDP remains inactive during a predetermined time in one or more active CRBs. In some embodiments, the NAN device Dev2 may determine that the NDP is inactive for the first duration if the first duration ends at a time belonging to an observation window located at the beginning of an active CRB and if the NDP remains inactive during a predetermined time in one or more active CRBs. In some embodiments, the predetermined time may be equal to the OW. In some embodiments, as described above, the NAN device Dev2 may determine that the NDP is inactive for the first duration, based on a timer which is reset with a reset value indicated by the NDP PS configuration parameter ndpInactivityTimeout_peer 2. The NDP PS configuration parameter ndpInactivityTimeout_peer_2 may be set equal to the received NDP PS configuration parameter ndpInactivityTimeout_self_1. The NDP PS configuration parameter ndpInactivityTimeout_peer_2 may be preconfigured. In some embodiments, the NAN device Dev2 may cancel the portion of the set of CRBs indicated by the NDP PS configuration parameter ndpDrxCrbs_peer_2 for transmitting data on the NDP if the NAN device Dev1 enters the DRX mode. The NDP PS configuration parameter ndpDrxCrbs_peer_2 may be set equal to the received NDP PS configuration parameter ndpDrxCrbs_self_1. The NDP PS configuration parameter ndpDrxCrbs_peer_2 may be preconfigured. In some embodiments, the NAN device Dev2 may be refrained from transmitting data to the NAN device Dev1 on the NDP during the cancelled portion of the set of CRBs.

In some embodiments, the NAN device Dev2 may determine that the NAN device Dev1 exits the DRX mode when the NAN device Dev2 determines that the NDP becomes active. When the NAN device Dev1 exits the DRX mode, the NAN device Dev2 may restore the cancelled portion of the set of CRBs and may be allowed to transmit data to the NAN device Dev1 on the NDP during the set of CRBs. In some embodiments, the NAN device Dev2 may determine that the NDP becomes active when the NAN device Dev2 determines that the NAN device Dev2 has made successful data transmission or reception on the NDP. In some embodiments, the NAN device Dev2 may determine that the NAN device Dev2 has made successful data transmission on the NDP when the NAN device Dev2 transmits a data frame to the NAN device Dev1 and receives an ACK frame in response to the data frame from the NAN device Dev1. In some embodiments, the NAN device Dev2 may determine that the NAN device Dev2 has made successful data reception on the NDP when the NAN device Dev2 receives a data frame from the NAN device Dev1 and transmits an ACK frame in response to the data frame to the NAN device Dev1. In some embodiments, the NAN device Dev2 may determine that the NAN device Dev1 exits the DRX mode when the NAN device Dev2 determines that the NDP becomes active in the NAN device Dev1. When the NAN device Dev1 exits the DRX mode, the NAN device Dev2 may restore the cancelled portion of the set of CRBs and may be allowed to transmit data to the NAN device Dev1 on the NDP during the set of CRBs. In some embodiments, the NAN device Dev2 may determine that the NDP becomes active in the NAN device Dev1 when the NAN device Dev2 determines that the NAN device Dev1 has made successful data transmission or reception on the NDP. In some embodiments, the NAN device Dev2 may determine that the NAN device Dev1 has made successful data transmission on the NDP when the NAN device Dev2 receives a data frame from the NAN device Dev1 and transmits an ACK frame in response to the data frame to the NAN device Dev1. In some embodiments, the NAN device Dev2 may determine that the NAN device Dev1 has made successful data reception on the NDP when the NAN device Dev2 transmits a data frame from the NAN device Dev1 and receives an ACK frame in response to the data frame from the NAN device Dev1.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An electronic apparatus for facilitating communication in a wireless network, the electronic apparatus comprising:
a memory; and
a processor operably coupled to the memory, the processor configured to cause:
establishing a data path with a wireless communication device;
agreeing on a set of resource blocks with the wireless communication device for communication on the data path;
transmitting, to the wireless communication device, a message indicating when the electronic apparatus cancels a portion of the set of resource blocks so that the wireless communication device is refrained from transmitting data to the electronic apparatus during canceled portion of the set of resource blocks on the data path; and
cancelling the portion of the set of resource blocks for receiving data on the data path, wherein the electronic apparatus is allowed not to listen on the data path during the cancelled portion of the set of resource blocks.

2. The electronic apparatus of claim 1, wherein the message indicates that the electronic apparatus cancels the portion of the set of resource blocks when a response to the message is received,
wherein cancelling the portion of the set of resource blocks comprises:
cancelling the portion of the set of resource blocks when the response to the message is received.

3. The electronic apparatus of claim 1, wherein the processor is further configured to cause:
restoring the cancelled portion of the set of resource blocks when successful data transmission or reception associated with the data path is made.

4. The electronic apparatus of claim 1, wherein the message indicates that the electronic apparatus cancels the portion of the set of resource blocks when the data path is inactive in the electronic apparatus for a duration,
wherein cancelling the portion of the set of resource blocks comprises:
determining whether the data path is inactive in the electronic apparatus for the duration, and
cancelling the portion of the set of resource blocks based on a determination that the data path is inactive in the electronic apparatus for the duration.

5. The electronic apparatus of claim 4, wherein determining whether the data path is inactive in the electronic apparatus for the duration comprises:
determining that the data path is inactive in the electronic apparatus for the duration when no successful data transmission or reception associated with the data path is made for the duration.

6. The electronic apparatus of claim 4, wherein the message includes a parameter indicating the duration.

7. The electronic apparatus of claim 4, wherein determining whether the data path is inactive in the electronic apparatus for the duration comprises:
determining that the data path is inactive in the electronic apparatus for the duration if the duration ends at a time belonging to an active resource block excluding an observation window located at the beginning of the active resource block.

8. The electronic apparatus of claim 4, wherein determining whether the data path is inactive in the electronic apparatus for the duration comprises:
determining that the data path is inactive in the electronic apparatus for the duration if the duration ends at a time not belonging to any active resource blocks and if the data path remains inactive during a predetermined time in one or more active resource blocks.

9. The electronic apparatus of claim 4, wherein determining whether the data path is inactive in the electronic apparatus for the duration comprises:
determining that the data path is inactive in the electronic apparatus for the duration if the duration ends at a time belonging to an observation window located at the beginning of an active resource block and if the data path remains inactive during a predetermined time in one or more active resource blocks.

10. The electronic apparatus of claim 1, wherein the message includes information indicating which portion of the set of resource blocks is cancelled.

11. The electronic apparatus of claim 1, wherein the portion of the set of resource blocks is preconfigured.

12. An electronic apparatus for facilitating communication in a wireless network, the electronic apparatus comprising:
a memory; and
a processor operably coupled to the memory, the processor configured to cause:
establishing a data path with a wireless communication device;
agreeing on a set of resource blocks with the wireless communication device for communication on the data path;
receiving, from the wireless communication device, a message indicating when the electronic apparatus cancels a portion of the set of resource blocks; and
cancelling the portion of the set of resource blocks for transmitting data on the data path based on the message, wherein the electronic apparatus is refrained from transmitting data to the wireless communication device on the data path during the cancelled portion of the set of resource blocks.

13. The electronic apparatus of claim 12, wherein the message indicates that the wireless communication device cancels the portion of the set of resource blocks when a response to the message is received,
wherein cancelling the portion of the set of resource blocks comprises:
cancelling the portion of the set of resource blocks when the response to the message is received.

14. The electronic apparatus of claim 12, wherein the processor is further configured to cause:
restoring the cancelled portion of the set of resource blocks when successful data transmission or reception associated with the data path is made.

15. The electronic apparatus of claim 12, wherein the message indicates that the wireless communication device cancels the portion of the set of resource blocks when the data path is inactive in the wireless communication device for a duration, and
wherein cancelling the portion of the set of resource blocks comprises:
determining that the data path is inactive in the wireless communication device for the duration, and
cancelling the portion of the set of resource blocks based on a determination that the data path is inactive in the wireless communication device for the duration.

16. The electronic apparatus of claim 15, wherein determining that the data path is inactive in the wireless communication device for the duration comprises:
determining that the data path is inactive in the wireless communication device for the duration when no successful data transmission or reception associated with the data path is made for the duration.

17. The electronic apparatus of claim 15, wherein the message includes a parameter indicating the duration.

18. The electronic apparatus of claim 15, wherein determining that the data path is inactive in the wireless communication device for the duration comprises:
determining that the data path is inactive in the wireless communication device for the duration if the duration ends at a time belonging to an active resource block excluding an observation window located at the beginning of the active resource block.

19. The electronic apparatus of claim 15, wherein determining that the data path is inactive in the wireless communication device for the duration comprises:
determining that the data path is inactive in the wireless communication device for the duration if the duration ends at a time not belonging to any active resource blocks and if the data path remains inactive during a predetermined time in one or more active resource blocks.

20. The electronic apparatus of claim 15, wherein determining that the data path is inactive in the wireless communication device for the duration comprises:
determining that the data path is inactive in the wireless communication device for the duration if the duration ends at a time belonging to an observation window located at the beginning of an active resource block and if the data path remains inactive during a predetermined time in one or more active resource blocks.
